(19) United States
(12) Patent Application Publication
(10) Pub. No.: US 2024/0276298 A1
(43) Pub. Date: Aug. 15, 2024

(54) REAL-TIME RAN INTELLIGENT CONTROLLER ARCHITECTURE

(71) Applicants: Altiostar Networks, Inc., Tewksbury, MA (US); RAKUTEN SYMPHONY SINGAPORE PTE. LTD., Singapore (SG)

(72) Inventors: Ankur Chauhan, Bangalore (IN); Antonio Forenza, San Mateo, CA (US); Manasi Padhy, Bangalore (IN); Sridhar Bhaskaran, Bangalore (IN)

(73) Assignees: Altiostar Networks, Inc., Tewksbury, MA (US); RAKUTEN SYMPHONY SINGAPORE PTE. LTD., Singapore (SG)

(21) Appl. No.: 18/023,243

(22) PCT Filed: Oct. 7, 2022
(86) PCT No.: PCT/US2022/046059

§ 371 Date: Feb. 24, 2023

Related U.S. Application Data
(63) Continuation of application No. PCT/US2022/025868, filed on Apr. 22, 2022.
(60) Provisional application No. 63/325,886, filed on Mar. 31, 2022.

(51) Int. Cl. H04W 28/08; H04L 41/16; H04W 88/12

(52) U.S. Cl. CPC H04W 28/09; H04W 28/0858; H04L 41/16; H04W 88/12

(57) ABSTRACT

An Open Radio Access Network (O-RAN) may include an O-RAN Centralized Unit (O-CU), at least one O-RAN Distributed Unit (O-DU), at least O-RAN Radio Unit (O-RU), and a Real-Time (RT) RAN Intelligent Controller (RIC) coupled to the at least O-DU and configured to host at least one application for controlling the at least one O-DU over a real-time control loop with a latency of less than 10 ms. The O-RAN wireless system may include a Non-RT (Non-RT) RIC configured to manage resources and events having a latency of 1 second or greater, and may include a Near-RT RIC configured to manage resources and events having a latency of 10 ms to 1 second. In addition, O-RAN may include a Service Management and Orchestrator (SMO) platform, where the RT RIC is connected to at least one of the SMO, the Non-RT RIC, the Near-RT RIC, RAN network elements and the O-RU.

### CROSS-REFERENCE TO RELATED APPLICATIONS

The present application claims priority to Provisional U.S. Patent Application No. 63/325886, filed on Mar. 31, 2022, and to International Application PCT/US2022/025868 filed on Apr. 22, 2022, the entire contents of each are herein wholly incorporated by reference.

### TECHNICAL FIELD

In some example embodiments, the subject matter herein generally relates to a Radio Access Network (RAN) (O-RAN) wireless communications and a more specifically to an Open Radio Access Network (O-RAN) and a RAN Intelligent Controller (RIC).

### BACKGROUND

A RAN is part of a wireless communication system. The RAN implements a Radio Access Technology (RAT) that resides between an end user and a Core Network (CN) of the wireless communication system. The RAN includes a combination of various network elements that connect the end user to the CN. Traditionally, the hardware and software elements of a given RAN is vendor specific.

O-RAN technology has emerged to enable an open RAN architecture. An O-RAN architecture is intended to improve competition, network flexibility, and cost. A primary goal of O-RAN is to create a multi-vendor solution that separates or disaggregates the RAN functions between hardware and software platforms with an open interfaces and virtualization.

Accordingly, O-RAN disaggregates RAN functions into a Centralized Unit (CU), a Distributed Unit (DU), and a Radio Unit (RU). The CU is a logical node for hosting Radio Resource Control (RRC), Service Data Adaption Protocol (SDAP), and/or Packet Data Convergence Protocol (PDCP) sublayers of the RAN. The DU is a logical node hosting Radio Link Control (RLC), Media Access Control (MAC), and Physical (PHY) sublayers of the RAN. The RU is a physical node that converts radio signals transmitted/received to digital signals that are transmitted/received over a Fronthaul to a DU. In O-RAN, these RAN functions/elements have open protocols and interfaces and therefore can be provided by different vendors.

The RAN functions in the O-RAN architecture are controlled by a RAN Intelligent Controller (RIC). The RIC is a software-defined component of the O-RAN architecture. The RIC enables onboarding of third-party applications that automate and optimize RAN operations at scale while supporting innovative use cases.

In the current O-RAN architecture the RIC is divided into two types, a Non-Real-Time RIC (Non-RT RIC) and a Near-Real-Time RIC (Near-RT RIC). In general, the Non-RT RIC provides the policies, data, and Artificial Intelligence (AI) models enforced and used by the Near-RT RIC to perform RAN optimization.

The Non-RT RIC is the control point of a non-real-time control loop and operates on a timescale greater that 1 second within a Service Management Orchestration (SMO) framework. The Near-RT RIC operates on a timescale between 10 ms and 1 second and connects to the O-DU, O-CU, and an Open evolved NodeB (O-eNB). Thus, the minimum latency between the Near-RT RIC and connected nodes is 10 ms.

High latency loops, for example 10 ms and higher, impede the use of AI models and multivendor intelligent management and control for real-time operations. Thus, the need exists for a Real-Time (RT) RIC performing O-RAN intelligent management in real-time.

### SUMMARY

In one general aspect, an apparatus implementing a Real-Time (RT) Radio Interface Controller (RIC) is provided. The apparatus implementing the RT RIC may include a memory configured to store a plurality of instructions. The apparatus may also include processor circuitry coupled to the memory and configured to execute the plurality of instructions to connect to at least one O-RAN Distributed Unit (O-DU) via an interface, and host at least one application controlling the at least one O-DU over a real-time control loop with a latency of less than 10 milliseconds (ms) via the interface. Other embodiments of this aspect include corresponding computer systems, apparatus, and computer programs recorded on one or more computer storage devices, each configured to perform the actions of the apparatus implementing the RT RIC.

Implementations may include one or more of the following features. The apparatus where the RT RIC is co-located with the at least one O-DU. The apparatus where the RT RIC is external to the at least one O-DU. The apparatus where the RT RIC is coupled with a Fronthaul Multiplexer (FHM). The apparatus implementing the RT RIC where the RT RIC is connected to: a Service Management and Orchestration (SMO) platform via a first interface, a Non-Real Time RIC (Non-RT RIC) via a second interface, a Near-Real Time RIC (Near-RT RIC) via a third interface, network components via a fourth interface, and an O-RAN Radio Unit (O-RU) via a fifth interface, where the RT RIC is connected to the SMO, Non-RT, Near-RT, network elements, and O-RU alone or in any combination. The apparatus may further include a plurality of open Application Programming Interfaces (APIs), each of the plurality open APIs hosting at least one application enabling communication with at least one of a plurality of submodule of the RT RIC via messaging infrastructure circuitry. The apparatus where the plurality of submodules of the RT RIC include at least one of: conflict management circuitry, subscription management circuitry, security circuitry, an Artificial Intelligence (AI) model, sensor management circuitry, hardware circuitry, data exposure circuitry, and a shared data lake. The apparatus where the shared data lake is part of an information architecture (IA) of the AI model. The AI module may be based on machine learning and deep learning techniques. The apparatus where the RT RIC is configured to connect with a primary O-DU and a secondary O-DU when performing carrier aggregation. Implementations of the described techniques may include hardware, a method or process, or a computer tangible medium.

In another general aspect, an Open Radio Access Network (O-RAN) wireless communication system is provided. The O-RAN wireless communication system may include an O-RAN Centralized Unit (O-CU), at least one O-RAN Distributed Unit (O-DU), at least O-RAN Radio Unit (O-RU), a Real-Time (RT) RAN Intelligent Controller (RIC) coupled to the at least O-DU via an interface and configured to host at least one application for controlling the at least one O-DU over a real-time control loop with a latency of less than 10 ms. The O-RAN wireless communication system may moreover include a Non-RT (Non-RT) RIC configured to manage resources and events having a latency of 1 second or greater, a Near-RT RIC configured to manage resources and events having a latency of 10 ms to 1 second, a Service Management and Orchestrator (SMO) platform, where the RT RIC is connected to the SMO via a first interface, the Non-RT RIC via a second interface, the Near-RT RIC via a third interface, RAN network elements via a fourth interface and the O-RU a fifth interface.

Implementations of the O-RAN wireless communication system may include one or more of the following features. The O-RAN wireless communication system where the RT RIC is co-located with the at least one O-DU. The O-RAN wireless communication system where the RT RIC is external to the at least one O-DU. The O-RAN wireless communication system where the RT RIC is coupled with a Fronthaul Multiplexer (FHM). The O-RAN wireless communication system where the RT RIC is configured with a plurality of open Application Programming Interfaces (APIs), each of the plurality open APIs hosting at least one application enabling communication with at least one of a plurality of submodules of the RT RIC via messaging infrastructure circuitry. The O-RAN wireless communication system where the plurality of submodules of the RT RIC include at least one of: conflict management circuitry, subscription management circuitry, security circuitry, an Artificial Intelligence (AI) model, sensor management circuitry, hardware circuitry, data exposure circuitry, and a shared data lake. The O-RAN wireless communication system where the shared data lake is part of an information architecture (IA) of the AI model. The O-RAN wireless communication system where the RT RIC is configured to connect with a primary O-DU and a secondary O-DU when performing carrier aggregation. Implementations of the described techniques may include hardware, a method or process, or a computer tangible medium.

In another general aspect, a method for implementing a Real-Time (RT) Radio Interface Controller (RIC) in an Open Radio Access Network (O-RAN) is provided. The method may include connecting the RT RIC to at least one O-RAN Distributed Unit (O-DU) via an interface. The method may also include hosting by the RT RIC at least one application controlling the at least one O-DU over a real-time control loop with a latency of less than 10 ms via the interface.

Implementations of the method may include one or more of the following features. The method may further include communicating with each of a plurality of submodules of the RT RIC with at least one of a plurality of open Application Programming Interface (API), each of the plurality open APIs hosting at least one application enabling communication with at least one of the plurality of submodules of the RT RIC via a messaging infrastructure where the plurality of submodules of the RT RIC include at least one of: conflict management circuitry, subscription management circuitry, security circuitry, an Artificial Intelligence (AI) model, sensor management circuitry, hardware circuitry, data exposure circuitry, and a shared data lake.

### BRIEF DESCRIPTION OF THE DRAWINGS

In the following drawings:

FIG. 1 illustrates a general architecture where a RT RIC is interfaced with more than one O-DU according to an example embodiment;

FIG. 2 illustrates a general architecture where a RT RIC is interfaced with more than one O-DU according to an example embodiment;

FIG. 3 is a block diagram of a RT RIC according to one or more example embodiments;

FIG. 4 illustrates the architecture of a RT RIC with RAN microservices according to an example embodiment;

FIG. 5 illustrates the architecture where RT RIC is hosted at a vDU along with the other RAN microservices;

FIG. 6 illustrates a configuration with a primary O-DU and secondary O-DU for carrier aggregation use cases; and

FIG. 7 depicts the logical view of a cell site consisting of multiple O-DUs, O-RU's, cabinets, and sensors.

### DETAILED DESCRIPTION

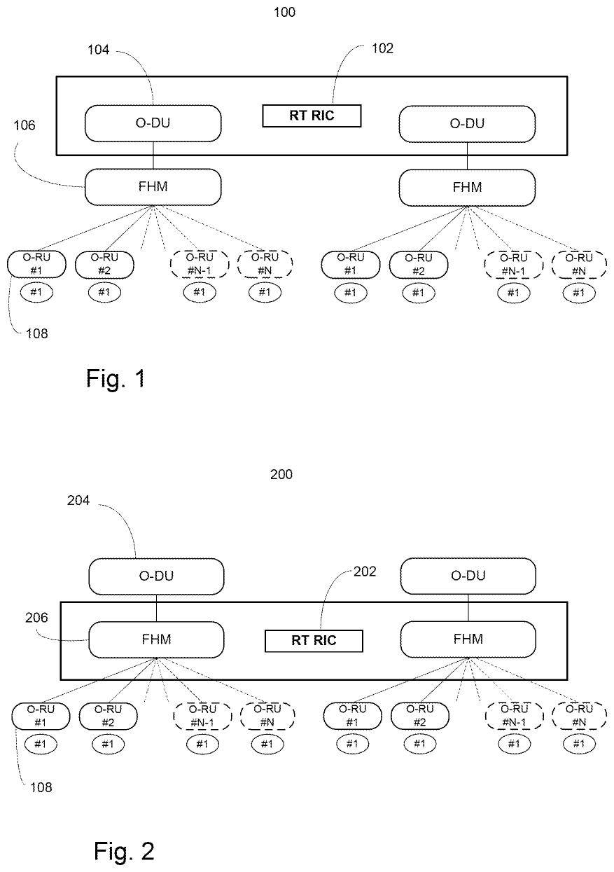

FIG. 1 illustrates a general architecture of the RT RIC (102) having an interface with more than one physically co-located O-DUs (104); in this architecture the RT RIC (102) may be hosted in any one of the O-DUs (104) or on an external unit. The RT RIC (102) may be implemented within the same processor (e.g., CPU, GPU, or any hardware accelerator) as the O-DU (104), or implemented in a different processor within the same motherboard, or on different motherboard within the same enclosure, or a separate enclosure within the same rack, or a separate rack within the same data center or on a separate unit. A DU (104) may establish communication with one or more RUs (108) through a FHM (106).

FIG. 2 illustrates a general architecture of the RT RIC (102) having an interface with more than one physically co-located FHM (106). Each FHM may be connected to or integrated with one or more DUs (104). In this architecture, the RT RIC may be implemented within the same processor (e.g., CPU, GPU, or any hardware accelerator) as the FHM, or a different processor within the same motherboard, or a different motherboard within the same enclosure, or separate enclosure within the same rack, or a separate rack within the same data center. The FHM may be configured to aggregate data or control information (e.g., SRS signals) between one or a plurality of O-RUs and the RT RIC.

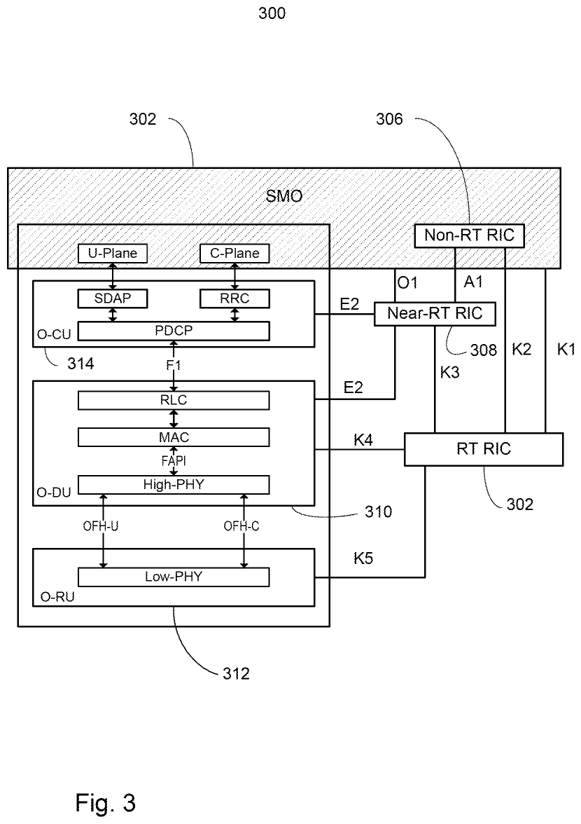

FIG. 3 is a block diagram of a RT RIC according to one or more example embodiments. RT RIC 302 may include a first interface (labeled, by way of non-limiting example, a K1 interface) that connects the RT RIC 302 to a SMO 304. The first interface may be an Operation and Maintenance interface implemented through standards or proprietary interfaces using the Network Configuration Protocol (NETCONF) or any other network management protocol. In an embodiment, the network management protocol is used for Provisioning Management Services to Create: Managed Object Instance, Delete Managed Object Instance, Modify Managed Object Instance Attributes and/or Read Managed Object Instance Attributes. In another embodiment, the first interface implements at least one of a plurality of services including: fault supervision management, performance assurance management, trace management, file management, heartbeat management, physical network function (PNF) startup and registration management, and/or PNF software management. In another embodiment, the K1 interface comprises reporting Performance Management (PM) counters or Fault Management (FM) alarms from RT RIC 302 to SMO 304.

The RT RIC 302 may include a second interface, labeled, by way of non-limiting example, a K2 interface, that connects the RT RIC 302 to a Non-RT RIC 306. The second interface enables the Non-RT RIC 306 to provide policy-based guidance, Machine Learning (ML) model management and enrichment information to the RT RIC 302 for optimizing the RAN. In an embodiment, the protocol stack of the second interface includes one or a plurality of layers such as Internet Protocol (IP), Transmission Control Protocol (TCP), Hypertext Transfer Protocol Secure (HTTPS), JavaScript Object Notation (JSON) and/or any other proprietary or standards layers.

The RT RIC 302 may include a third interface, labeled, by way of non-limiting example, a K3 interface, that connects the RT RIC 302 to a Near-RT RIC 308. The third interface enables the Near-RT RIC 308 to provide policy-based guidance, ML model management and enrichment information to the RT RIC 302 for optimizing the RAN. In an embodiment, the protocol stack of the third interface may include at least one of a plurality of layers including IP, TCP, HTTPS, JSON and/or any other proprietary or standards layers. In another embodiment, the K3 interface is modelled as the O-RAN standard-compliant E2 interface (i.e., E2AP over SCTP). The Near-RT RIC 308 connects to a O-CU 314 and a O-DU 310 via, by way of non-limiting example, an E2 interface.

In addition, by way of non-limiting example, the Near-RT RIC 308 connects with SMO 302 via an O1 interface and connects with the Non-RT RIC 306 via a A1 interface.

A fourth interface (labeled, by way of non-limiting example, a K4 interface) connects the RT RIC 302 to a logical network element 310. One skilled in that art will appreciate that the logical network element illustrated in FIG. 3 is an O-DU 310, the RT RIC 302 may be logically connected to at least one of a plurality of network elements including at least one of an O-DU, O-CU-CP, O-CU-UP or O-eNB.

The fourth interface enables different services of the RT RIC 302 (e.g., report, insert, control, and policy) and support functions (e.g., interface management, service update, etc.)

The RT RIC 302 may include a fifth interface, labeled, by way of non-limiting example, a K5 interface that connects to an O-RU 312. The fifth interface is a direct logical channel or interface used for exchanging data and/or control information between the RT RIC 302 and at least one of a plurality of O-RUs 312 by implementing control, user and synchronization planes.

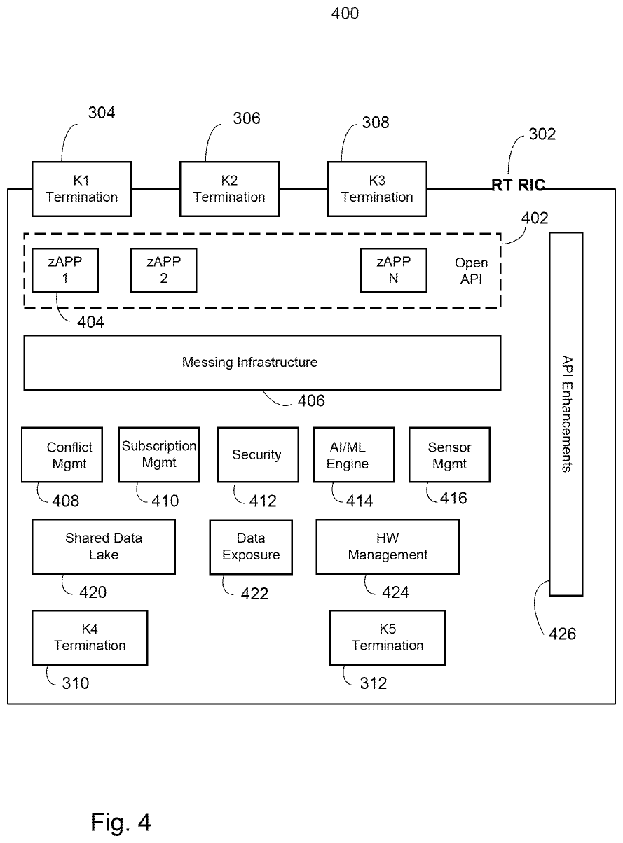

FIG. 4 is a block diagram of the architecture of a RT RIC 302 with RAN microservices according to an example embodiment. Open APIs 402 illustrated in FIG. 4 refer to a set of APIs which are exposed by the RT RIC 302 platform using zApps 404 which may interact with and get services from the RT RIC 302. zApps 404 may be viewed as similar to rApps which may be implemented in a Non-RT RIC and xApps which may be implemented in a Near-RT RIC. zApps, however, are RT RIC applications.

With reference to FIG. 3, it is understood that RT RIC 302 includes connections that terminate at the SMO 304 (K1 termination), the Non-RT RIC (K2 termination), the Near-RT RIC 308 (K3 termination), Network elements (K4 termination), and the O-RU 312 (K5 Termination).

Messaging Infrastructure 406 is a messaging framework that enables a zApp 404 to communicate with the internal submodules of RT RIC 302 and maybe implemented in multiple ways.

Conflict Management submodule 408 refers to the component which resolves the conflicts caused by different requests initiated by different zApps. Conflict can be partial or complete. While resolving the conflicts, conflict management module 408 may contact z subscription management module 410 and may utilized subscription and priority information while resolving the conflict.

Subscription Management submodule 410 stores the subscription time information while a zApp 404 is on boarded, subscription information can include but is not limited to holding the access permissions (application priority) for the open API's.

A Security submodule 412 ensures the security and stability of the RT RIC, third party zApp 404 needs to comply with the security framework enabled in the RT RIC, security framework enables the data protection, zero trust provisioning for any zApps 404 on boarded,

An AI/ML 414 Engine submodule process data present in a shared data lake 420 and creates the policies/configurations much faster. It should be understood that AI engine 414 may include Machine Learning (ML) and/or Deep Learning techniques. The shared data lake 420 is part of an information architecture (IA) of the AI model.

ML may work in two phases, training and inference. In the training phase data is feed into the model so it may learn everything it can about the type of data analyzed. In the inference phase, the model may make predictions based on real-time data to produce actionable results. In deep learning, a deep neural network (DNN) may learn how to analyze a set of data and make predictions about the data. Deep learning relies on feedback so that the system learns from incorrect conclusions.

Data Exposure submodule 422, which may be referred to as a service, controls and ensures the exposure of data to an application, for example the zAPPs. Some data coming from O-RU (K5 termination 312) may be exposed/accessed by a single application or high priority applications, even if a low-priority application has access permission this data may not be able to access it until a higher priority application is registered. Data Exposure submodule 422 may control this access. In addition, data Exposure submodule 422 may control how long the RT RIC 302 must store a particular set of data, and Data Exposure submodule 422 may implement data sharing techniques, for example push and pull operations.

A Sensor Management, submodule 416 gets the input from all sensors present at a cell site, the sensors may cabinet temperature, wind load, antenna tilt, clutter images and the like.

A Hardware management submodule 424 may get information from hardware present at the cell site, which may include average/peak CPU/memory utilization, average/peak utilization of Fronthaul interface and the like. API Enhancements may be implemented via API Enhancements module 426.

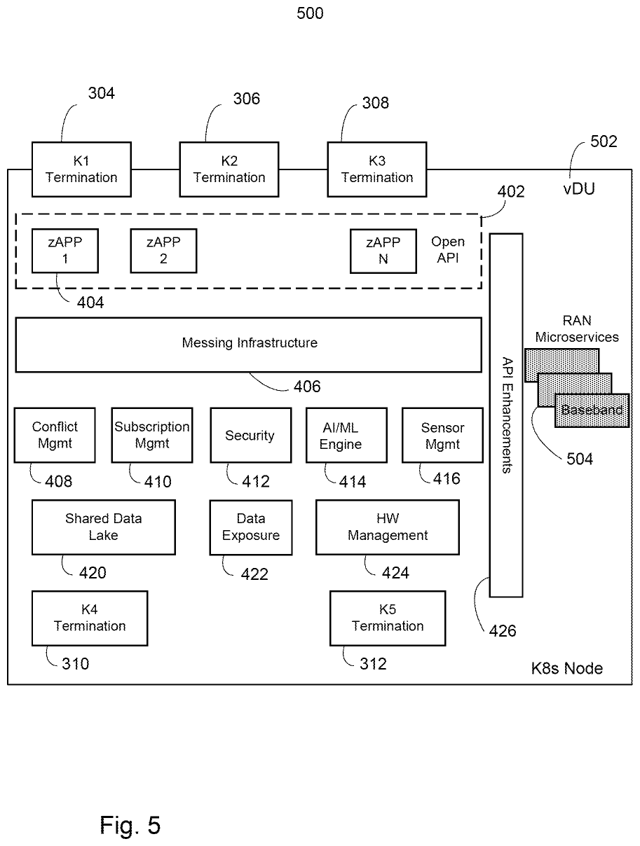

FIG. 5 illustrates an architecture where a RT RIC is hosted at a virtual DU (vDU) 502 along with the other RAN microservices 504. A vDU may be implemented in a cloud-native architecture. This may be implemented as a K8s Node. K8s Nodes may also be referred to as a Kubernetes Node which provides a logical collection or grouping of nodes that run containerized applications. Microservices 504 functions may include control and data plane functions as well as baseband functions.

Greenfield 5G networks may be deployed on a 5G network core referred to as a standalone architecture (SA). However, migration from 4G to 5G requires overlaying a new 5G RAN on an existing 4G LTE network core. This is referred to a non-standalone architecture (NSA).

NSA deployed networks may be upgraded to 5G SA networks by implementing software upgrades to the 4G O-DUs. Performing carrier aggregation from co-located O-DUs requires real-time coordination among the O-DUs.

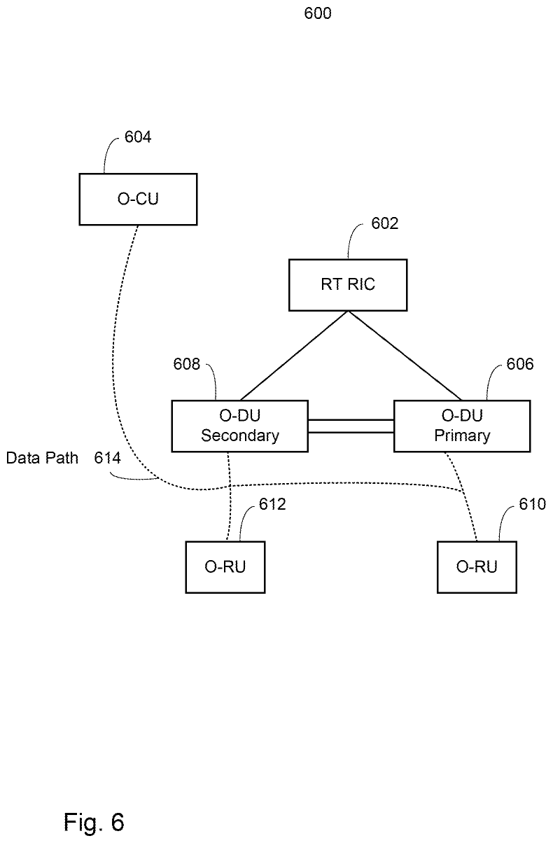

FIG. 6 illustrates a RT RIC 602 connected to a primary O-DU 606 which is the O-DU that takes care of aggregating the traffic, and a secondary O-DU 608 which shares the secondary carrier data with primary O-DU for carrier aggregation. The RLC is anchored on one of the DUs since a mobile device of UE is associated with only one RLC. In an embodiment, the RLC of the primary O-DU 606 has real-time communication with the MAC of the secondary O-DU 608. In another embodiment, a shared memory is used to hold the RLC buffer across the two O-DUs. In an embodiment the two DUs may be on the same compute or Non-uniform memory access (NUMA) node and share memory. In another embodiment, the two DUs are on separate machines and use distributed shared memory that synchronizes at a sub Transmission Time Interval (TTI) real-time granularity and avoids memory contentions. A RT RIC 602 and/or zApp hosts the RLC itself. Then the CU-UP 604 directly sends downlink packets to zApp. The RLC buffer in zApp then decides to which cell's MAC to send the packet (i.e., primary vs secondary O-DU) and which O-DU to activate via MAC and data paths 614. Data paths 614 provide connections between the O-CU 604, primary O-DU 606, secondary O-DU 608, O-RU 610, and O-RU 612.

Carrier aggregation may be performed with any combination of TDD and/or FDD carriers based on the technology currently existing/presents in the related standards. Additionally, the carrier aggregation application hosted at RT RIC 602 may collect data regarding a delay due to the MAC entity running on physically separate O-DU's. A zApp hosted at RT RIC 602 may decide which MAC entity to do the carrier aggregation, and the decision can be based on the delay observed, current schedular policy configured, channel conditions, buffer status at RLC of the carriers involved and the bearer priority.

A zApp running on the RT RIC 602 may configure the MAC scheduler running on the primary O-DU 606 to minimize the impact of the delay due to the physical separation of the O-DUs, this approach includes at least one of the following:
a) Scheduling the data on the secondary carrier in advance in-order to minimize the impact of the delay occurred due to the physical separation of the O-DUs;
b) Optimization of the HARQ configurations in-order to minimize the delay impact due to the physical separation of the O-DU's; and
c) Predicting the HARQ process outcome on the secondary carrier based on the channel conditions and/or delay,

The above processes may be implemented alone or in any combinations according to the zApp. These zApp configurations form the RT-RIC 602 policies for O-DU (606 and/or 608) and or O-RU (610 and/or 612). The RT RIC 602 policies for the carrier aggregation can be different for different carriers based on the Quality of service and network slice configuration.

Coverage and capacity requirements for each operator may be significantly different, in a typical NSA deployment the LTE layer (typically FDD) may work as a coverage layer, while the 5G layer provides the capacity, in a case of upgrading the network to the SA architecture, it may be desirable by some of the operators to keep the experience intact even after moving to the SA architecture by doing carrier aggregation. This requires a schedular to be updated with the resource allocation policies, change in the fairness attributes and with other configurations.

In a case of configuration conflict at an O-DU from the Near RT RIC and from RT RIC, the configurations from RT RIC 602 may take precedence. Additionally, the RT RIC 602 can store the configurations/policies from Near-RT RIC and/or Non-RT RIC in order to reduce the conflict.

For a carrier aggregation use case where each carrier is running on physically separate O-DUs, zApps running on RT RIC 602 can take care at least the following operations:
a) For a case where a zApp is not present, carrier aggregation works as described in the prior arts;
b) The RT RIC 602 may enable a zApp to get configuration information from Near-RT RIC, Non-RT RIC, SMO and/or from a O-DU itself, this information makes the RT RIC 602 aware of the current configuration policies.
c) In a case of a configuration conflict at an O-DU (606 and 608) from the configuration received from RT RIC 602 and Near- RT RIC, configuration from RT RIC 602 takes precedence. In general, the possibility of this conflict may be low since the RT RIC 602 works on the real time loop and may work mostly with MAC/PHY layers configurations.
d) A zApp responsible for carrier aggregation takes the delay into consideration that may be caused, in this case, due to physically separate O-DU's (606/608) on which primary and secondary carriers are running, while configuring the O-DUs along with the policies related to coverage and capacity enhancements. The RT RIC 602 may enable configuration to the MAC, MAC schedular and other components running at O-DU (606/608).

In an embodiment, the zApp manages the RLC buffer. In another embodiment, the primary O-DU 606 manages the RLD buffer.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

After the transformation of phones into smart phones, a similar transformation is now being witnessed at the network side, where the intelligence at the cell site is improving and it is powered by the HW sensors present the cell site, monitoring aspects related to Temperature, humidity, wind load, tower load, camera's capturing clutter images, cabling images. Some of this information requires a Real-Time response.

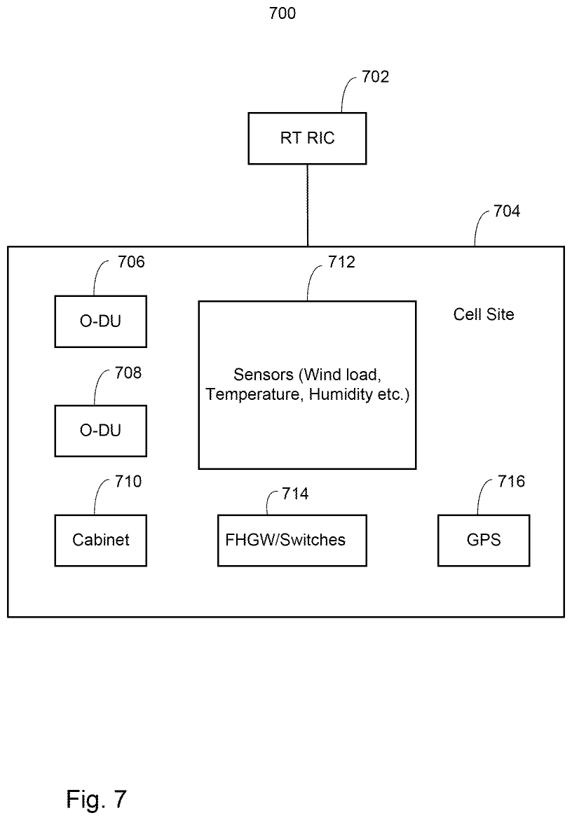

FIG. 7 illustrates the logical view of a cell site. A cell site 704 may consist of multiple O-DUs 706, O-RU's 708, Cabinet 710, multiple sensors 712, Fronthaul (FH) gateway/switches 714, and GPS 716.

In one aspect, a RT RIC 702 may measure the current load faced by components of the cell site 704 including the wind load. If the current load faced by various components of the cell site 704 get close to the load capacity of the tower or other components of the cell site 704, a zApp hosted at the RT RIC 702 can take prevention measures to avoid any damage or reduce the temporary strain faced by the components of the cell site 704. In addition, if this phenomena occurs frequently at any particular site, the RT RIC 702 can pass recommendations to the Operational Support System (OSS)/Business Support System (BSS) modules. Some scenarios where a real-time response from RT RIC 704 may be very crucial are the following.
a) Sudden Increase of Site Load:
   i) Solutions include, reducing wind load by changing the tilt and/or directions of the antenna. Further, in these solutions the RT RIC 702/zApp may already have the site/tower load capacity information which can be determined at the time of cell site 704 installation, and a zApp hosted at the RT RIC 702 might calculate the current capacity of the site by using AI/ML techniques and the current age of the site;
   ii) In addition to the solution described above, when the current load at the site become close to the cell site 704 capacity, the AI/ML algorithms zApp hosted at the RT RIC 702 may calculate the effective changes in the antenna/O-RU 708 tilt and direction with which there is a minimal impact on the user experience while the current load at the site is reduced; and
   iii) The threshold value described above can be different and it is based on the Antenna panel size and massive MIMO (mMIMO) configurations.
b) Increase of the cabinet temperature:
   i) Solutions include a reduction of the CPU processing load to prevent system break down. One of the zApps hosted at the RT RIC 702 can monitor the current state of the temperatures, configuration of CPU's and load on each CPU;
   ii) The solution further includes the analysis of reduction of the CPU load in the temperature reduction along with the CPU load reduction impact on system performance including data. The AI/ML algorithms hosted at the RT RIC 702 may help zApp to calculate this co-relation; and
   iii) In addition to the solution described above, a zApp may determine a specific action which may result in temperature reduction by a specific amount with the minimal impact on system performance.
      This action may include the following;
a) the reduction of the mMIMO configurations, for example from 64T64R to 8T8R;
b) Reduction in the number of physical sectors, for example 3 physical 4T4R sectors getting changed to 2 Physical 2*2T2R sectors; and
c) Reduction in the number of spatial layers for mMIMO.
   c) Backup power source:
i) In a typical site deployment there is a main power source and one or more backup power sources are provided to provide continuous power to the site in case main power source is not available. However, the cost of the backup power source is typically high and is available for a limited amount of time. A zApps hosted at the RT RIC 702 monitors the pattern of when the main power source is not available and the duration for which backup power source is used. The AI/ML algorithms at the RT RIC 702 may help the zApp to predict the usage of the backup power source. In an aspect, the zApp raises an alarm to the SMO when main power source fails or is about to fail. In another embodiment, the SMO may either instruct the zApp/RT RIC 702 to take energy savings action or take actions shutting down certain RUs/carriers at the site.
   ii) In addition to the solution provided above, the zApp makes a tradeoff among capacity, coverage and power consumption having least impact on users. This tradeoff is dynamic in nature as well as specific to the cell site 704. The RT RIC 702 is positioned to host this application.

This use case may be alternatively handled by having stronger HW requirements. However, this increases the cost exponentially and even in worst case scenarios may be for a relatively short duration, like an increase in wind load during a hurricane. Using SW and AI/ML based approach implemented with the RT RIC 702 is efficient and cost effective.

Application running over the Non-RT and Near-RT RIC may utilize over 4000 key performance indicators (KPIs) to collect data from the RAN and analyze the data to adjust its algorithms improving performance of the wireless access links between RUs and UEs. The industry standard for the periodicity to update the KPIs is 15 minutes. This is a large delay number considering that the Near-RT RIC operates on a time scale between 10 msec and 1 sec. To accommodate the real-time component of the RIC, the KPI periodicity may be reduced. As a non-limiting example, some of the typical periodicity values for different applications and KPIs are the following.
1. eSON in 4G-LTE
   a. Interference management
      i. UE throughput: 2 sec
      ii. UE measurement report: 5 sec
      iii. UE SINR report: 2 sec
   b. Load balancing
      i. Load information (capacity): 10 sec
2. xApps in 5G-NR.
   a. xApps
      i. PRB utilization: 5 sec
      ii. HARQ ACK-NACK: 5 sec

While reduced KPI periodicity allows higher granularity that yields higher performance gains, it comes at the cost of higher overhead over the transport, specifically over the Fronthaul and F1, E2, A1, O1 interfaces and especially when the KPI periodicity is below 1 sec. One way to avoid large overhead for transport is to keep all or most of the KPIs used for real-time applications as close as possible to the DU. Because Non-RT RIC and Near-RT RICs are not implemented close to the DU with a low latency control loop to process all those KPIs, large overhead for transport may not be avoided.

Defining the RT RIC as close as possible to the DU/RU is required to collect and analyze all the KPIs related to the wireless access, train the AI/ML models based on the KPIs and to perform ML inference. In an embodiment, one or a plurality of the KPIs are sent to the Shared Data Lake 420 as shown in FIG. 4. In another aspect, the KPIs at the data lake are used to train the AI/ML model inside the AI/ML engine 414 illustrated in Fig.4, and the AI/ML engine 414 performs inference. In a another aspect, AI/ML training is performed at the Non-RT RIC 306 by sending the KPIs over the E2, A1, and O1 interfaces as shown in FIG. 3 either alone or in combination, and AI/ML inference is performed at the RT RIC.

Other variations to the disclosed embodiments can be understood and effected by those skilled in the art in practicing the claimed features, from a study of the drawings, the disclosure, and the appended claims.

In the claims, the word “comprising” does not exclude other elements or steps, and the indefinite article “a” or “an” does not exclude a plurality.

A single processor, device or other unit may fulfill the functions of several items recited in the claims. The mere fact that certain measures are recited in mutually different dependent claims does not indicate that a combination of these measures cannot be used to advantage.

Operations like acquiring, accessing, analyzing, capturing, comparing, determining, displaying, inputting, obtaining, outputting, providing, store or storing, calculating, simulating, receiving, warning, and stopping can be implemented as program code means of a computer program and/or as dedicated hardware.

A computer program may be stored and/or distributed on a suitable medium, such as an optical storage medium or a solid-state medium, supplied together with or as part of other hardware, but may also be distributed in other forms, such as via the Internet or other wired or wireless telecommunication systems.

Claims:

1. An apparatus implementing a Real-Time (RT) Radio Interface Controller (RIC) in an Open Radio Access Network (O-RAN), the apparatus comprising:
a memory configured to store a plurality of instructions;
processor circuitry coupled to the memory and configured to execute the plurality of instructions to:
connect to at least one O-RAN Distributed Unit (O-DU) via an interface; and
host at least one application controlling the at least one O-DU over a real-time control loop with a latency of less than 10 milliseconds (ms) via the interface.

2. The apparatus according to claim 1, wherein the RT RIC is co-located with the at least one O-DU.

3. The apparatus according to claim 1, wherein the RT RIC is external to the at least one O-DU.

4. The apparatus according to claim 1, wherein the RT RIC is coupled with a Fronthaul Multiplexer (FHM).

5. The apparatus according to claim 1, wherein the RT RIC is connected to:
a Service Management and Orchestration (SMO) platform via a first interface;
a Non-Real Time (Non-RT) RIC via a second interface;
a Near-Real Time (Near-RT) RIC via a third interface;
network components via a fourth interface; and
an O-RAN Radio Unit (O-RU) via a fifth interface, wherein the RT RIC is connected to the SMO, Non-RT, Near-RT, network elements, and O-RU alone or in any combination.

6. The apparatus according to claim 1, wherein the apparatus further comprises a plurality of open Application Programming Interfaces (APIs), each of the plurality open APIs hosting at least one application enabling communication with at least one of a plurality of submodule of the RT RIC via messaging infrastructure circuitry.

7. The apparatus according to claim 6, wherein the plurality of submodules of the RT RIC include at least one of: conflict management circuitry, subscription management circuitry, security circuitry, an Artificial Intelligence (AI) model, sensor management circuitry, hardware circuitry, data exposure circuitry, and a shared data lake.

8. The apparatus according to claim 7, wherein the shared data lake is part of an information architecture (IA) of the AI model.

9. The apparatus according to claim 6, wherein the RT RIC is configured to connect with a primary O-DU and a secondary O-DU when performing carrier aggregation.

10. An Open Radio Access Network (O-RAN) wireless communication system comprising:
an O-RAN Centralized Unit (O-CU);
at least one O-RAN Distributed Unit (O-DU);
at least O-RAN Radio Unit (O-RU);
a Real-Time (RT) RAN Intelligent Controller (RIC) coupled to the at least O-DU via an interface and configured to host at least one application for controlling the at least one O-DU over a real-time control loop with a latency of less than 10 ms;
a Non-RT (Non-RT) RIC configured to manage resources and events having a latency of 1 second or greater;
a Near-RT RIC configured to manage resources and events having a latency of 10 ms to 1 second; and
a Service Management and Orchestrator (SMO) platform, wherein the RT RIC is connected to at least one of the SMO via a first interface, the Non-RT RIC via a second interface, the Near-RT RIC via a third interface, RAN network elements via a fourth interface or the O-RU via a fifth interface either alone or in any combination.

11. The O-RAN wireless communication system according to claim 10, wherein the RT RIC is co-located with the at least one O-DU.

12. The O-RAN wireless communication system according to claim 10, wherein the RT RIC is external to the at least one O-DU.

13. The O-RAN wireless communication system according to claim 10, wherein the RT RIC is coupled with a Fronthaul Multiplexer (FHM).

14. The O-RAN wireless communication system according to claim 13, wherein the RT RIC is configured with a plurality of open Application Programming Interfaces (APIs), each of the plurality open APIs hosting at least one application enabling communication with at least one of a plurality of submodules of the RT RIC via messaging infrastructure circuitry.

15. The O-RAN wireless communication system according to claim 14, wherein the plurality of submodules of the RT RIC include at least one of: conflict management circuitry, subscription management circuitry, security circuitry, an Artificial Intelligence (AI) model, sensor management circuitry, hardware circuitry, data exposure circuitry, and a shared data lake.

16. The O-RAN wireless communication system according to claim 15, wherein the shared data lake is part of an information architecture (IA) of the AI model.

17. The O-RAN wireless communication system according to claim 14, wherein the RT RIC is configured to connect with a primary O-DU and a secondary O-DU when performing carrier aggregation.

18. A method for implementing a Real-Time (RT) Radio Interface Controller (RIC) in an Open Radio Access Network (O-RAN), the method comprising:
connecting the RT RIC to at least one O-RAN Distributed Unit (O-DU) via an interface; and
hosting by the RT RIC at least one application controlling the at least one O-DU over a real-time control loop with a latency of less than 10 ms via the interface.

19. The method according to claim 18, further comprising communicating with each of a plurality of submodules of the RT RIC with at least one of a plurality of open Application Programming Interface (API), each of the plurality open APIs hosting at least one application enabling communication with at least one of the plurality of submodules of the RT RIC via a messaging infrastructure.

20. The method according to claim 19, wherein the plurality of submodules of the RT RIC include at least one of: conflict management circuitry, subscription management circuitry, security circuitry, an Artificial Intelligence (AI) model, sensor management circuitry, hardware circuitry, data exposure circuitry, and a shared data lake.
